(19) United States
(12) Patent Application Publication
(10) Pub. No.: US 2015/0298333 A1
(43) Pub. Date: Oct. 22, 2015

(54) MACHINE AND METHOD FOR FOR CUTTING THE SIDE WALLS OF TIRES AT THE END OF LIFE

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Michel BLONDELET, Clermont-ferrand (FR); Alberto MATTAROZZI, Clermont-ferrand (FR); Andre PALLOTTA, Clermont-ferrand (FR); Patrick RENE, Clermont-Ferrand (FR)

(21) Appl. No.: 14/443,931

(22) PCT Filed: Nov. 19, 2013
(86) PCT No.: PCT/EP2013/074196

§ 371 Date: May 19, 2015

(30) Foreign Application Priority Data
Nov. 19, 2012 (FR) 1260955

(51) Int. Cl. B26D 3/00; B26D 7/02; B26D 7/26; B26D 5/20

(52) U.S. Cl. CPC B26D 3/005; B26D 5/20; B26D 7/02; B26D 7/2628

(57) ABSTRACT

Machine for cutting off the sidewalls of a tire, which comprises, in combination:
a frame;
connecting means configured to connect the tire in a pre-established position with respect to the frame, in a zone for loading said tire;
at least one head equipped with at least one cutting blade for cutting off a sidewall of the tire;
manipulation means that act in operation on said tire or on said cutting head in order to allow said cutting blade to be set into relative movement with respect to the tire;
means for adjusting the relative position of the blade with respect to the connecting means, which act in operation on said blade or on the connecting means for the tire in order to allow the blade to be positioned such that, during said relative movement, the blade cuts off the sidewall of the tire along its circumference.

This application is a 371 national phase entry of PCT/EP2013/074196, filed 19 Nov. 2013, which claims benefit of French Patent Application No. 1260955, filed 19 Nov. 2012, the contents of which are incorporated by reference herein for all purposes.

### BACKGROUND

1. Field

The present disclosure relates to a machine and a method for cutting off the sidewalls of tires, in particular heavy duty tires, at the end of life.

The machine and method are used in the technical sector of recycling tires at the end of life.

2. Description of Related Art

The term “heavy duty tires” should be understood as meaning tires having a particularly large diameter, such as 57″ and 63″ tires, for example (these dimensions relating to the inside diameter of the rim). These tires are generally employed in earth-moving machines used in the mining sector.

A need that is particularly desired, in particular in the field of heavy duty tires, is the ability to separate the sidewalls from tires in a particularly simple and rapid manner, for the purpose of their disposal/subsequent processing. In particular, in the sector in question, there is the need to separate the two sidewalls of the tire from the cap thereof.

Documents which deal with the separation of the sidewalls from the cap of a tire are known from the prior art. Thus, the documents DE 2344479, DE 4200949 and FR 2780675 describe devices for cutting off the sidewalls of tires in order to separate them from the cap of the same tire. However, none of these devices is provided to carry out the separation of the sidewalls of a heavy duty tire.

### SUMMARY

One object of embodiments of the present invention is thus to provide an original solution to the abovementioned needs, by producing a machine for cutting off the sidewalls of a heavy duty tire, and also a method for cutting off the sidewalls of a heavy duty tire, which meet the need set out above.

Another object of an embodiment of the present invention is to make available a machine for cutting off sidewalls which is easily adaptable to processing tires of various sizes.

In accordance with an embodiment of the invention, these objects are achieved by a machine for cutting off the sidewalls and by a method for cutting off the sidewalls that are subjects of the invention, comprising the technical features set out in the main claims thereof.

The machine for cutting off the sidewalls of a tire according to an embodiment of the invention is characterized in that it comprises, in combination:
a frame;
connecting means configured to connect the tire in a pre-established position with respect to the frame, in a zone for loading said tire, the connecting means for the tire comprising a carousel;
a block disposed on the carousel, said block being adjustable in height and intended to support the external part of the bead of the tire that comes into contact with said carousel;
at least one head equipped with at least one cutting blade for cutting off a sidewall of the tire;
manipulation means that act in operation on said tire or on said cutting head in order to allow said cutting blade to be set into relative movement with respect to the tire; and
means for adjusting the relative position of the blade with respect to the connecting means, which act in operation on said blade or on the connecting means for the tire in order to allow said blade to be positioned such that, during said relative movement, the blade cuts off the sidewall of the tire along its circumference.

In this way, it is possible to cut off the sidewalls of tires having very different sizes and masses, and in particular to process tires intended for heavy equipment very ergonomically and safely.

According to an embodiment of the invention, when a height-adjustable block that is intended to support the external part of the bead of the tire that comes into contact with said carousel is disposed, the threads of the carcass reinforcement ply are tensioned, thereby making the action of the cutting tool more effective. A height-adjustable block is understood to be either an assembly brought about by a stack of mechanical parts of different heights, or a mechanical device of the electric, hydraulic or pneumatic cylinder type, the stem of which is set in movement after having been brought into abutment against the external part of the bead in order to obtain different values of the tension in the threads of the carcass ply. Such tensioning of the sidewall of the tire makes it easier for the cutting blade to open the sidewall, and also to cut off the sidewall around the perimeter of the circumference.

### BRIEF DESCRIPTION OF DRAWINGS

According to the abovementioned objectives, the complementary technical features of embodiments of the invention are clearly verifiable from the content of the secondary claims mentioned below and the advantages thereof will become even more apparent from the following detailed description which is given with reference to the attached drawings, which show an embodiment that serves as an implementation example of the invention and is not limiting, and in which:

FIG. 1 shows a plan view of a machine that is the subject of an embodiment of the present invention in a first configuration;

FIG. 2 illustrates a side view of a machine that is the subject of an embodiment of the present invention with a tire disposed in the loading zone;

FIG. 3 illustrates a front lateral elevation view of a detail of the machine shown in the preceding figures;

FIG. 4 illustrates a plan view of the machine shown in the preceding figures with a tire disposed in the loading zone;

FIGS. 5 and 6 each illustrate a side view of a detail of the machine shown in the preceding figures, with a tire disposed in the loading zone;

FIGS. 7 and 8 illustrate a detail of the machine that is the subject of an embodiment of the present invention.

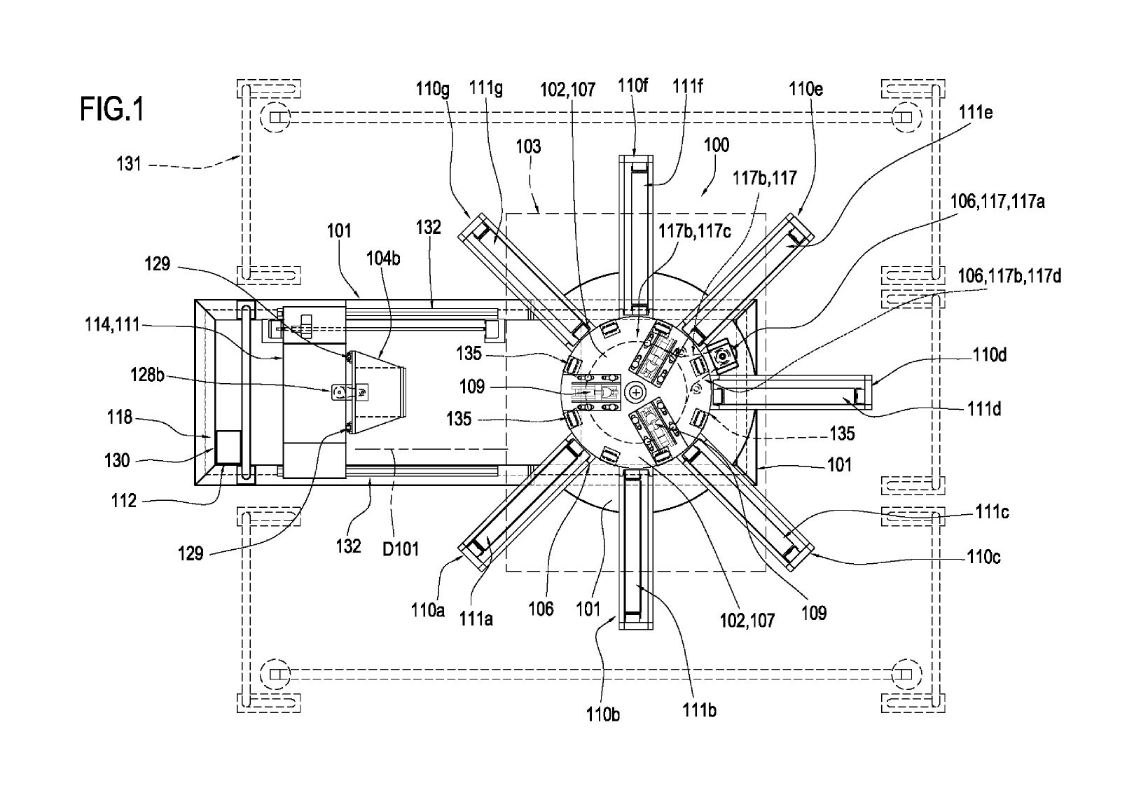

### DETAILED DESCRIPTION OF SPECIFIC EMBODIMENTS

In accordance with the attached drawings, the piece of equipment or the machine for cutting off the sidewalls (2a, 2c) of tires 2 at the end of life is designated 100.

The expression “cutting off the sidewalls” is understood as meaning the separation of the sidewalls (2a, 2c) from the cap 2b, comprising the tread, of the tire 2 as such.

The machine 100, which will be described in the following text, is configured to carry out the operation of cutting off the sidewalls (2a, 2c) of tires 2 of the heavy duty type, that is to say having large dimensions with, in a non-limiting manner, a diameter of between thirty-three inches and sixty-three inches (diameter of the rim).

The machine 100 comprises a frame 101 and means 102 for connecting the tire with respect to the frame 101, said means 102 being configured to connect the tire 2 in a pre-established position with respect to the frame 101, corresponding to a loading zone 103 for said tire 2.

According to the example illustrated by way of non-limiting example, the connecting means 102 are configured to clamp the tire in a position in which the axis thereof is approximately vertical. According to the embodiment illustrated, the connecting means 102 for the tire 2 comprise a carousel 107 and means 108 for clamping the tire with respect to the carousel 107 as such.

In particular, the means 108 for clamping the tire 2 with respect to the carousel 107 are able to move between a releasing position P100 and a clamping position P101 in which they act on a sidewall 2a (in particular on the internal surface of this sidewall 2a) of the tire 2 in order to clamp the tire 2 to the carousel 107.

These clamping means 108 comprise a clamping element 133 that is able to move between said releasing position P100 and clamping position P101, and means 109 for manipulating and actuating said clamping element 133. In particular, according to the application example, the clamping element 133 pivots in a hinged manner with respect to the carousel 107.

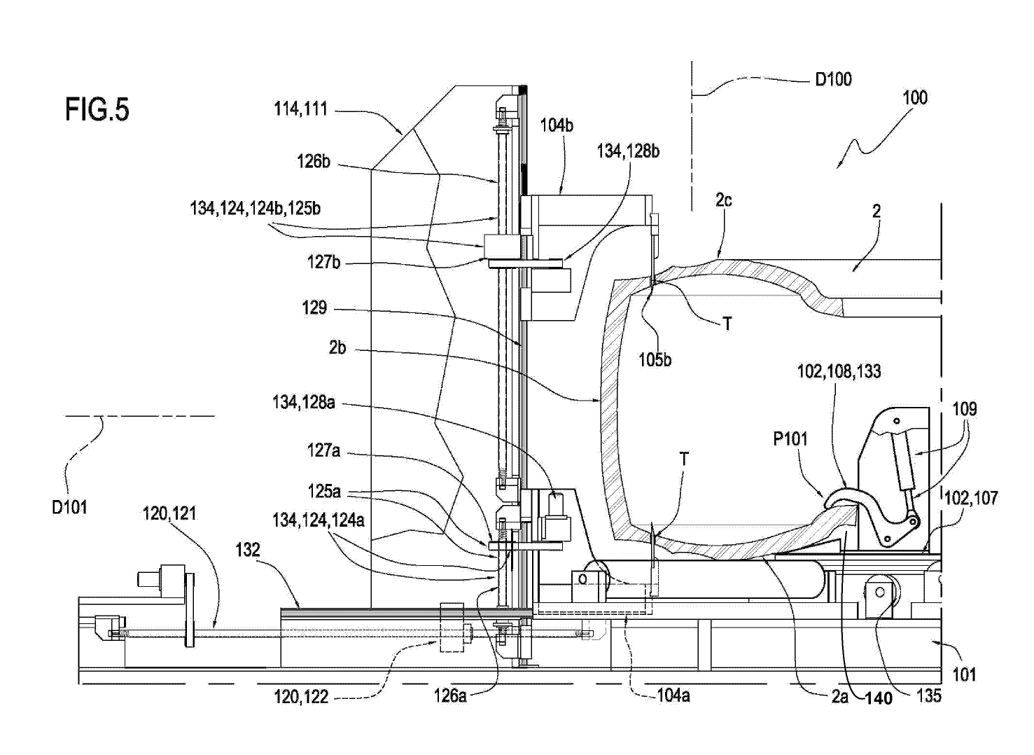

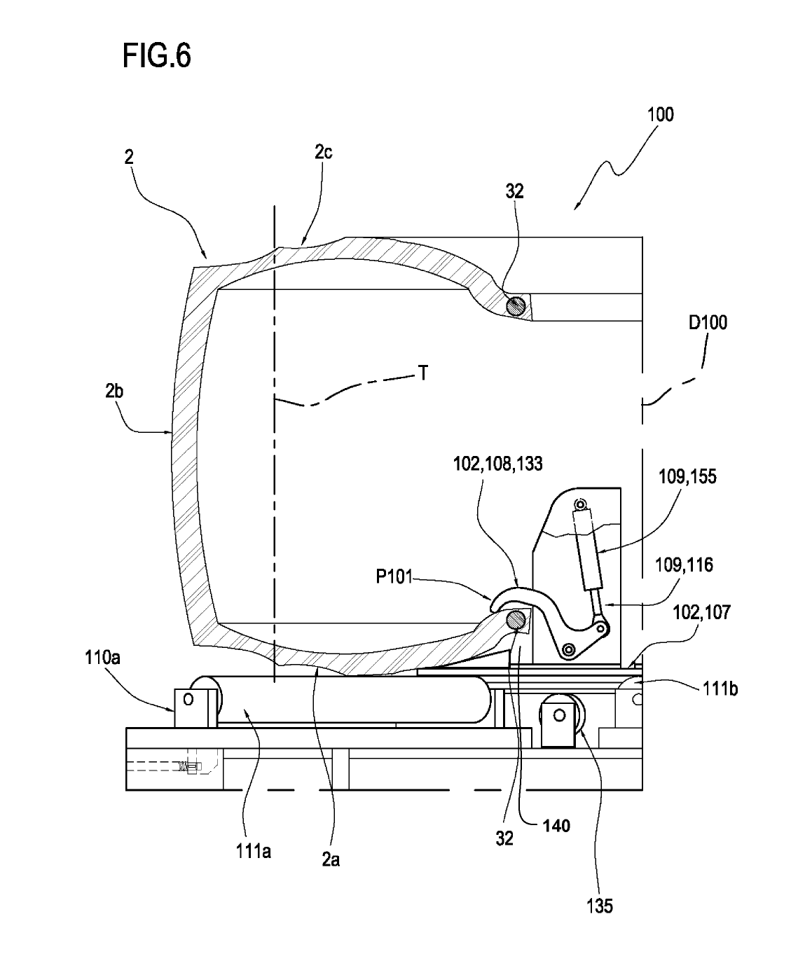

According to an embodiment of the invention, in order to make it easier to cut the sidewall, it is preferable, as illustrated in FIGS. 5 and 6, to dispose a height-adjustable block 140 that is intended to support the external part of the bead of the tire that comes into contact with said carousel. The increase in height of the block has the effect of tensioning threads of the reinforcing ply and of making the cutting tool more effective. It goes without saying that the raising of the block 140 is limited to the position in which the detachment of the sidewall 2a of the tire from the plateau 111a is observed.

In the example illustrated, the manipulation and actuation means 109 comprise a pneumatic cylinder 155 comprising a piston 116 that slides with respect thereto: either the cylinder 155 or the piston 116 is linked (by a hinge) to the clamping element 133 and the other element of the cylinder 155 and the piston 116 is linked (by a hinge) to the carousel 107. The carousel 107 is configured to rotate (with respect to the frame 101) about a (vertical) axis X100. Consequently, such a carousel 107 makes it possible to set the tire 2 in rotation about said (vertical) axis X100. In particular, the carousel 107 is supported in a rotating manner with respect to the frame 101 by means of a plurality of rotary elements 135.

According to an embodiment of the invention, the machine 100 comprises at least one cutting head (104a, 104b) equipped with at least one cutting blade (105a, 105b) for cutting off a sidewall (2a, 2c) of the tire 2 along the circumference.

The expression “cutting off a sidewall along the circumference” should be understood as meaning cutting the sidewall along a substantially annular cutting line T, about the axis of the tire 2. In the embodiment illustrated in the appended figures, the machine comprises a pair of cutting heads (104a, 104b).

Each cutting head (104a, 104b) is provided with at least one cutting blade 105a, 105a′, 105b, 105b′, respectively, configured to cut off one of the two sidewalls (2a, 2c) of said tire 2. In other words, the first cutting head 104a is intended to cut off a first sidewall 2a of the tire 2 along its circumference and the second cutting head 104b is intended to cut off the second sidewall 2c, opposite the first sidewall 2a, of the tire 2 along its circumference.

In the example illustrated, each cutting head (104a, 104b) is equipped with a pair of blades that work together. Referring to the first cutting head 104a, it will be seen that this cutting head 104a comprises a first blade 105a and a second blade 105a′, while the second cutting head 104b comprises a third blade 105b and a fourth blade 105b′.

These cutting heads (104a, 104b) are configured to cooperate so as to cut off the two sidewalls (2a, 2c) of the tire 2 at substantially the same time, as will be described in more detail below.

According to an embodiment of the invention, the machine 100 comprises manipulation means 106 for setting the tire 2 in rotation with respect to the cutting blades (105a, 105a′, 105b, 105b′), which act in operation on the tire 2 or on the cutting head (104a, 104b) in order to allow a relative movement of the cutting blade (105a, 105a′, 105b, 105b′) with respect to the tire 2.

In the embodiment illustrated, the means 106 for relative manipulation comprise the carousel 107 and the means 117 for rotating the carousel as such, these being described in more detail below.

The means 117 for rotating the carousel comprise a motor 117a and means 117b for transmitting the movement of the motor 117a to the carousel 107 as such. Preferably, the means 117b for transmitting the movement of the motor to the carousel 107 as such comprise a toothed wheel 117c, coupled to the carousel 107, and a chain 117d, connected to the motor 117a.

The cutting blade (105a, 105a′, 105b, 105b′) may be positioned with respect to the tire 2 so as to cut off the sidewall (2a, 2c) of the tire 2 along the circumference during the relative movement of the cutting blade (105a, 105a′, 105b, 105b′) with respect to the tire 2. More generally, the invention thus comprises means 114 for adjusting the relative position of the blade(s) (105a, 105a′, 105b, 105b′) with respect to the connecting means 102, which act in operation on said blade(s) (105a, 105a′, 105b, 105b′) or on the connecting means 102 for the tire 2 in order to adjust the relative position of the blade(s) (105a, 105a′, 105b, 105b′) with respect to the tire 2 such that, during said relative movement, the blade (105a, 105a′, 105b, 105b′) cuts off the sidewall (2a, 2c) of the tire 2 along its circumference.

According to an embodiment of the embodiment of the invention that is the subject of the present description, the connecting means 102 also comprise a plurality of radial elements (110a, 110b, 110c, 110d, 110e, 110f, 110g), disposed radially outside the carousel 107 in order to serve as a support for at least a part of a sidewall 2a of the tire 2.

These radial elements (110a, 110b, 110c, 110d, 110e, 110f, 110g) are fixed with respect to the frame 101. In particular, each of said radial elements (110a, 110b, 110c, 110d, 110e, 110f, 110g) comprises an element (111a, 111b, 111c, 111d, 111e, 111f, 111g) that rotates with respect to a (substantially horizontal) axis Y100. This rotating element (111a, 111b, 111c, 111d, 111e, 111f, 111g) is configured to serve as a support for a part of the sidewall 2a of said tire 2. This rotating element (111a, 111b, 111c, 111d, 111e, 111f, 111g) is preferably of the free type. Thus, when the tire 2 is clamped with respect to the carousel 107 and driven in rotation thereby, the sidewall (2a, 2c) of the tire slides on the rotating elements (111a, 111b, 111c, 111d, 111e, 111f, 111g), driving them in rotation.

The construction aspects relating to the cutting heads (104a, 104b) according to the preferred embodiment of the machine 100 will be described in detail below.

In the illustrated embodiment of the machine 100, the cutting heads (104a, 104b) are carried by one and the same slider 111. This slider 111 is able to move with respect to the connecting means 102 (carousel 107 and clamping means 108), so as to make it possible to radially adjust the position for cutting off the sidewall of the tire 2 (that is to say the cutting line T) with respect to said tire 2. The slider 111 thus defines, in the example illustrated, means 114 for adjusting the position of the blade with respect to the connecting means 102 (carousel 107 and clamping means 108). The slider 111 is configured to allow the cutting blades (105a, 105a′, 105b, 105b′) to be disposed such that the cutting line T is in a radially pre-established position of the tire 2. The slider 111 is able to move, in a direction D101, on a slideway 132 that is part of the machine 100. The direction D101 is a horizontal direction.

The machine 100 comprises means 119 for manipulating the slider 111. In the embodiment illustrated, these manipulation means 119 comprise a mechanism 120. The endless screw mechanism 120 comprises an endless screw 121, connected to the frame 101, an element 122, coupled in terms of screwing to this endless screw 121 and connected to the slider 111, and a motor 123 for driving the coupling element 122 and the endless screw 121 in relative rotation so as to allow the slider 111 to move along the slideway 132.

The cutting heads (104a, 104b) are coupled in a movable manner to the slider 111. These cutting heads (104a, 104b) move in a (vertical) direction D100 that is substantially at right angles to the direction D101 of movement of the slider 111. Moreover, the cutting heads (104a, 104b) are able to move in a direction D100 substantially parallel to the axis X100 of rotation of the carousel 107. Each cutting head (104a, 104b) is equipped with means 124 for manipulation with respect to the slider 111.

Preferably, the means 124 for manipulation of one cutting head 104a are independent of those for the other head 104b: in particular, the means for manipulation of the first cutting head 104a have been designated 124a, while those of the second cutting head 104b have been designated 124b.

The means (124a, 124b) for manipulation of the cutting head (104a, 104b) with respect to the slider 111 each comprise an endless screw mechanism (125a, 125b).

The endless screw mechanism (125a, 125b) comprises an endless screw (126a, 126b) connected to the slider 111, a coupling element (127a, 127b), coupled in terms of screwing to this endless screw (126a, 126b) and connected to the cutting head (104a, 104b), and motorizing means (128a, 128b) for driving the coupling element (127a, 127b) and the screw (126a, 126b) in relative rotation, so as to allow the cutting head (104a, 104b) to move with respect to the slider 111. The endless screw (126a, 126b) is prevented from moving with respect to the slider 111, and the coupling element (127a, 127b) is coupled to the motor means (128a, 128b) in order to be set in rotation with respect to the screw (126a, 126b) so as to allow the cutting head (104a, 104b) to move in translation with respect to the slider 111.

In the example illustrated, the motorizing means (128a, 128b) are carried by the cutting heads (104a, 104b). Each cutting head (104a, 104b) is mounted in a sliding manner on a slideway 129 associated with the slider 111.

The machine 100 also comprises command and control means 112 for said means 106 for relative manipulation of the blade (105a, 105b) with respect to the tire 2, said command and control means 112 being configured to regulate the speed of the relative movement of the blade (105a, 105b) with respect to the tire 2. These command and control means 112 are integrated into a command and control unit 130 of the machine 100.

The machine 100 may also comprise detection means 113 for picking up a signal s1 that is representative of a vibration relating to the cutting operation, or a vibration caused by cutting itself. Preferably, these detection means 113 are associated with the cutting head (104a, 104b) or the cutting blade (105a, 105a′, 105b, 105b′). The detection means 113 may also comprise at least one sensor configured to pick up an acceleration signal.

In a more preferred manner, each cutting head (104a, 104b) comprises one of said acceleration sensors.

More generally, the first cutting head 104a comprises first means 113a for detecting a vibration relating to the cutting operation and the second cutting head 104b comprises second means 113b for detecting a vibration relating to the cutting operation.

According to a first configuration of the machine 100, the detection means 113 are connected to the command and control means 112 in order to make available to the latter the signal s1 that is representative of a vibration relating to cutting, and the command and control means 112 are configured to regulate the speed of relative blade/tire 2 movement depending on the value of said signal s1.

In other words, the command and control means 112 are configured to regulate the speed of the means 106 for relative tire 2/cutting blade manipulation according to a function that is substantially opposite to the level of vibration picked up. This opposite function may be a continuous or discontinuous function. In addition, the command and control means 112 may be configured such that the abovementioned regulation only occurs when a given threshold or a picked-up vibration value is exceeded.

Thus, if the picked-up vibration level connected with cutting increases, the speed of relative movement of the blade (105a, 105a′, 105b, 105b′) with respect to the tire 2 is decreased. This is because it has been observed that cutting is more difficult in given zones of the tire 2, in particular where a reinforcement structure comprising small steel cords is present. This adjustment makes it possible to reduce wear to the cutting blades, to reduce the risk of damaging them and also to increase the effectiveness of cutting.

The machine 100 comprises command and control means 118 for the means 134 for adjusting the relative position of the blade(s) (105a, 105a′, 105b, 105b′) with respect to the surface of a sidewall (2a, 2c) of said tire 2, in other words for adjusting the depth of cutting.

According to the example illustrated, the means 134 for adjusting the depth of cutting are formed by the means 124, already described above, for manipulating the head (104a, 104b) with respect to the slider 111.

The command and control means 118 may be integrated into a hardware or software module of the command and control unit 130 of the machine 100. These means 118 are connected to the detection means 113 in order to receive a signal s1 that is representative of a vibration relating to cutting and are configured to adjust the relative position of the blade (105a, 105b) with respect to the surface of a sidewall (2a, 2c) of said tire 2, that is to say the depth of pass, depending on the value of said signal s1.

The command and control means 118 are configured to adjust the depth of pass (insertion of the blade into the sidewall (2a, 2c) in a direction substantially parallel to the axis of the tire 2 or perpendicular to the surface of the sidewall) according to an opposite function to the picked-up level of vibration.

In an analogous manner to everything that has been described above, provision is made to reduce the depth of pass in zones of the tire where, on account of the presence of small steel cables or other structural support elements, cutting produces high levels of vibration: this avoids any fatigue of the members of the machine, reduces wear to the blade and makes it possible to optimize the cutting conditions.

It is also possible to combine the adjustment of the depth of pass with the regulation of the speed of movement of the means 106 for relative manipulation, both of which have already been described above.

The operation of the machine 100 will be described below with reference particularly to an application example which should not, however, be considered limiting.

The operator loads the tire 2 in the loading zone 103, that is to say he disposes the tire 2 in a manner resting against the carousel 107.

In the case of tires 2 having particularly large dimensions, such as tires having a diameter of fifty-seven or sixty-three inches (this dimension referring to the inside diameter of the rim), for example, provision is made for one of the sidewalls to rest partially against the radial elements (110a, 110b, 110c, 110d, 110e, 110f, 110g).

In the clamping configuration or configuration for transfer by the connecting means 102, the tire 2 is disposed with its axis substantially vertical, resting against one of the two sidewalls (2a, 2c).

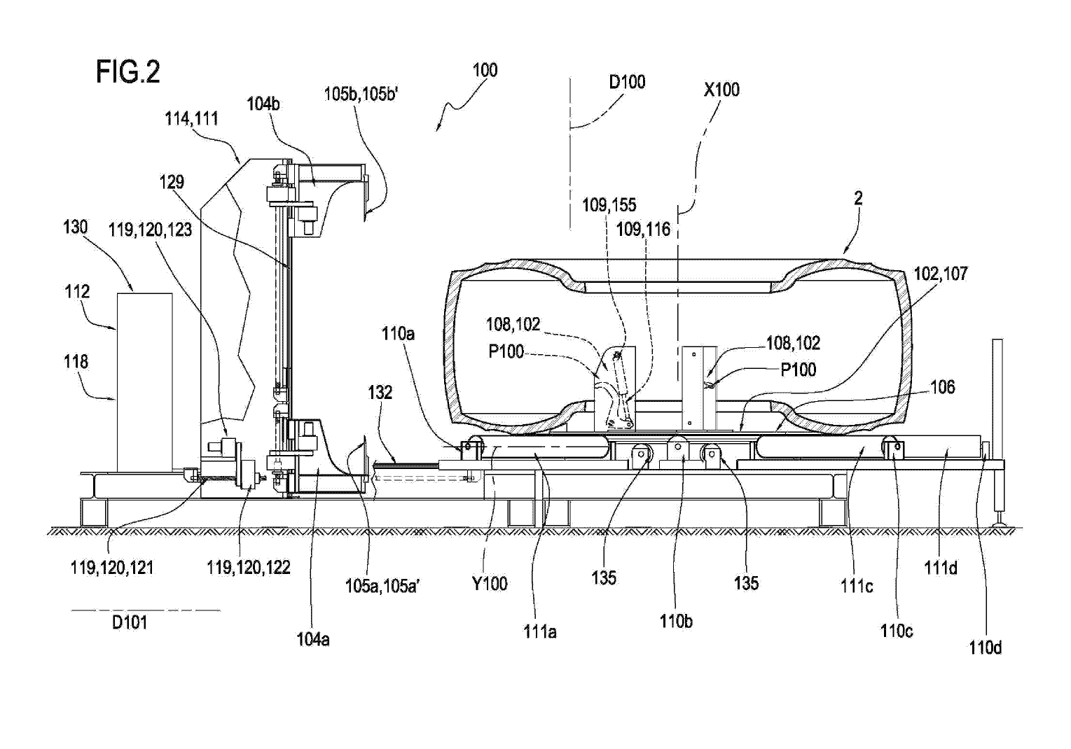

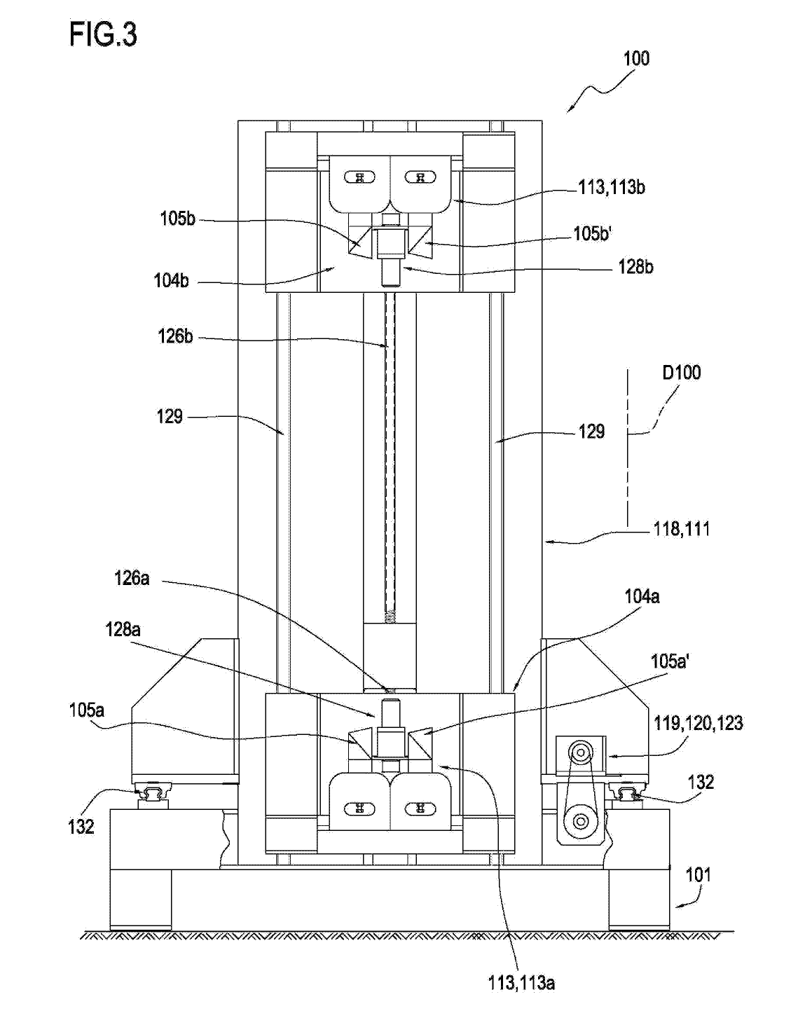

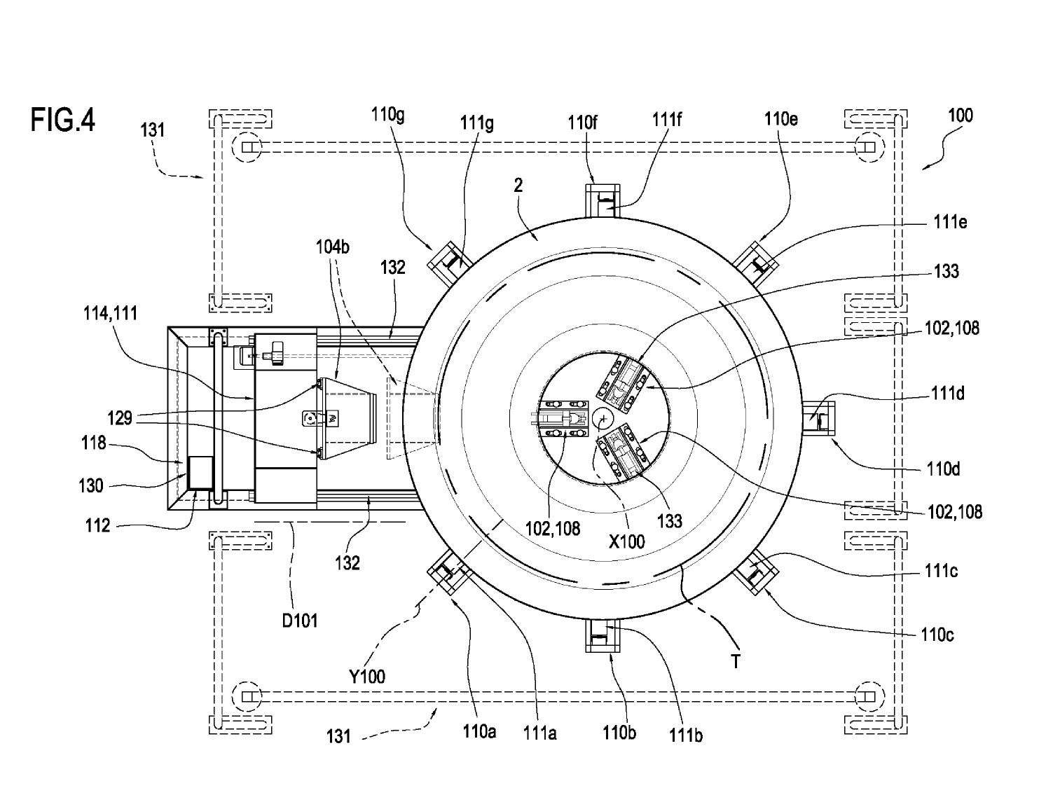

The clamping element 133 is actuated from the releasing position P100 (FIG. 2) to the clamping position P101 (FIG. 5) so as to clamp the sidewall 2a against the carousel 107 as such. In the clamping configuration, the tire 2 is connected with respect to the carousel 107 so as to be driven in rotation by the carousel 107 as such.

The operator positions the cutting heads (104a, 104b) in order to carry out the circumferential cut on a preselected line T or in a cutting zone, as is shown in FIG. 5. Generally, the sidewall (2a, 2c) is cut in the vicinity of the junction zone between the cap 2b and the sidewall (2a, 2c).

Provision can thus be made for each sidewall (2a, 2c) to be cut such that the sidewall (2a, 2c) separated from the cap 2b comprises the circumferential steel stiffening cord 32.

The blades (105a, 105a′) of the first cutting head 104a are disposed in contact with the first sidewall 2a, substantially facing (below) the latter.

The blades (105b, 105b′) of the second cutting head 104b are disposed in contact with the second sidewall 2c, substantially facing (above) the latter.

The carousel 107 is driven in rotation such that the cutting blades (105a, 105a′, 105b, 105b′) cut off the corresponding sidewalls (2a, 2c) along their circumference.

The cutting action of the first cutting head 104a may be delayed such that the complete separation of the second sidewall 2c (the one disposed at the top in the attached figures) from the cap 2b takes place prior to that of the first sidewall 2a (the one disposed at the bottom in the attached figures): this avoids the possibility of the tire 2 sagging or deforming incorrectly, making cutting difficult or even impeding it.

To this end, the first cutting head 104a is brought into contact with the corresponding sidewall 2a to be cut after the second cutting head 104b has already cut a part of the circumference of the second sidewall 2c of the tire 2.

According to one variant of the embodiment described above, the cutting blades (105a, 105a′; 105b, 105b′) of each cutting head (104a; 104b) are disposed at different heights in the direction of penetration into the sidewall (that is to say vertically in the illustrated figures).

The carousel 107 is set in rotation in a direction in which the sidewall (2a, 2c) is subjected, in order, first of all to the cutting action of the blade (105a, 105b) disposed further from the surface of the sidewall (2a, 2c) in the direction of penetration, and subsequently to the cutting action of the blade (105a′, 105b′) disposed closer to the sidewall (2a, 2c) in the direction of penetration: this advantageously makes it possible to distribute the cutting of each sidewall between the two blades (105a, 105a′; 105b, 105b′) and to reduce the forces necessary for cutting and the wear to the blades themselves.

Each blade (105a, 105a′; 105b, 105b′) has a cutting profile that is substantially inclined with respect to the supporting surface of the tire.

The carousel 107 is rotated as long as the first and second sidewall (2a, 2c) have not been cut off. In this way, the tire 2 is divided into three parts: a first sidewall 2a, a second sidewall 2c and a cap 2b.

The machine 100 may also be equipped with means 131 for detecting the presence of a person in an operating zone delimiting this machine 100, these means being configured to make available a signal s2 relating to the presence of a person in this operating zone. The command and control unit 130 is thus configured to stop the means 106 for relative manipulation if the presence of a person in said operating zone has been detected.

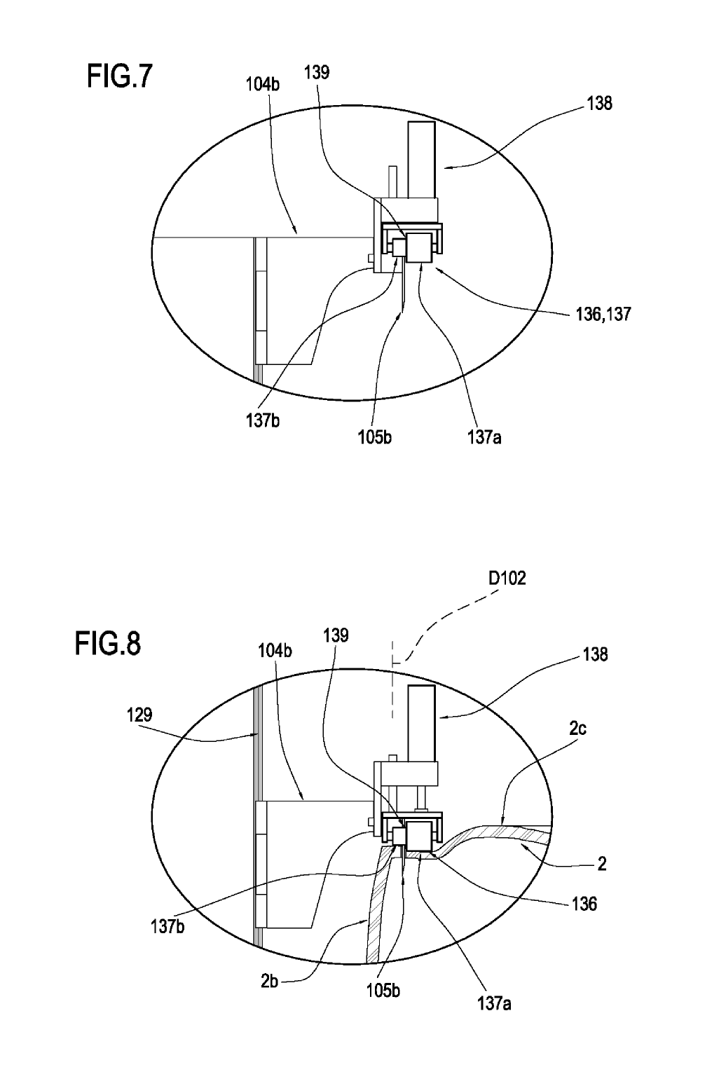

According to another aspect of the invention, the machine 100 comprises pressing means 136 (dearly shown in FIGS. 7 and 8). These pressing means 136 are configured to act on one of the two sidewalls (2a, 2c) of the tire 2.

In particular, the pressing means 136 comprise a rotary element 137 configured to rotate about a rotation axis during the relative movement of the tire 2 with respect to the cutting blades (105a, 105a′, 105b, 105b′). This rotary element 137 is preferably of the free type, and can be formed for example from one or more rollers.

In the embodiment that is the subject of the present description, the pressing means 136 are associated with a cutting unit 104b, in particular with the upper cutting unit 104b. The roller 137 is carried by the cutting unit 104b such that it is able to move in a direction D102 of movement (this direction is preferably parallel to the axis of the tire 2, that is to say vertical).

The pressing means 136 comprise an actuator 138 configured to manipulate the rotary component 137 in the direction of movement D102. The roller 137 acts on the surface of the sidewall 2c, coming into contact therewith and exerting a pressure on the surface in the zone in which the circumferential cut takes place. The roller 137 thus facilitates the cutting of the sidewall 2c and enables the action of the blade on the sidewall 2c. It makes it possible to move the zone of the sidewall close to the cutting blade at a pre-established height, compensating for any irregularities or unevennesses in height (bosses) present on the sidewall 2c itself, before these unevennesses come into contact with the blade.

Moreover, the roller 137 has a part 137a with a larger diameter and a part 137b with a smaller diameter. A shoulder 139 is delimited between the two parts 137a and 137b. The fact that the two parts 137a and 137b of the roller 137 have different diameters from one another makes it possible to exert a spacing-apart action on the sidewall 2c, this facilitating the cutting action of the blade. Specifically, the parts of the sidewall 2c that are separated by the cutting line T are subjected to an action on the part of one or the other of the two parts (137a and 137b) of the roller 137; this facilitating cutting by the blade.

During use, the larger-diameter part 137a is disposed proximally with respect to, or close to, the axis of the tire 2, while the smaller-diameter part 137b is disposed distally with respect to, or further away from, the axis of the tire 2.

In another aspect, which is not shown in the appended figures, the machine 100 comprises a sensor configured to pick up the distance between the blade and the cap 2b. This sensor makes it possible to pick up the position of the cap 2b with respect to the frame 101 and to deduce therefrom the position of the tire 2 with respect to the same frame 101. The control unit 130 is thus configured to radially position the blade depending on the position of the cap 2b. This affords the advantage of making it possible to follow the action of the blade, such that it is possible to carry out a circumferential cut, even when the axis of the tire is not centred with respect to that of the carousel 107.

The invention, in an embodiment, also relates to a method for cutting off the sidewalls (2a, 2c) of a tire 2, comprising the steps of:
providing a frame (101);
providing connecting means (102) configured to clamp the tire (2) in a pre-established position with respect to the frame (101), in a zone (103) for loading said tire 2, the connecting means (102) for the tire (2) comprising a carousel (107);
disposing a height-adjustable block (140) that is intended to support the external part of the bead of the tire that comes into contact with said carousel;
providing at least one cutting head (104a, 104b) equipped with a cutting blade (105a, 105a′, 105b, 105b′) for cutting off a sidewall (2a, 2c) of said tire (2);
disposing the cutting blade (105a, 105a′, 105b, 105b′) in contact with the sidewall (2a, 2c);
applying a relative movement to said blade (105a, 105b) and to said tire (2) such that, during said relative movement, the cutting blade (105a, 105b) makes a cut along the circumference of the sidewall (2a, 2c) of the tire (2).

1. A machine for cutting off the sidewalls of a tire, comprising:
a frame;
connecting means configured to connect the tire in a pre-established position with respect to the frame, in a zone for loading said tire, the connecting means for the tire comprising a carousel;
a block disposed on the carousel, said block being adjustable in height and intended to support the external part of the bead of the tire that comes into contact with said carousel;
at least one head equipped with at least one cutting blade for cutting off a sidewall of the tier;
manipulation means that act in operation on said tire or on said cutting head in order to allow said cutting blade to be set into relative movement with respect to the tire;
means for adjusting the relative position of the blade with respect to the connecting means, which act in operation on said blade or on the connecting means for the tire in order to allow said blade to be positioned such that, during said relative movement, the blade cuts off the sidewall of the tire along its circumference.

2. The machine according to claim 1, wherein said connecting means for the tire comprise a carousel configured to rotate about an axis and set the tire in rotation about said axis, and wherein said means for relative movement act in operation on said carousel in order to rotate the tire with respect to said cutting blade.

3. The machine according to claim 2, wherein said connecting means for the tire comprise means for clamping the tire with respect to the carousel, said means being able to move between a releasing position and a clamping position in which they act on a sidewall of the tire in order to clamp the tire to the carousel.

4. The machine according to claim 3, further comprising manipulation and drive means for the clamping means, said manipulation and drive means being configured to manipulate the clamping means between said releasing and clamping positions.

5. The machine according to claim 2, wherein the connecting means comprise a plurality of radial elements, disposed radially towards the outside of the carousel in order to serve as a support for at least a part of a sidewall of the tire.

6. The machine according to claim 5, wherein each of said radial elements comprises an element that is able to rotate with respect to an axis and is configured to serve as a support for a part of the sidewall of said tire.

7. The machine according to claim 1, wherein the cutting head is able to move radially with respect to said connecting means in order to allow radial adjustment of the position for cutting off the sidewall of the tire along its circumference.

8. The machine according to claim 1, further comprising a pair of cutting heads, each cutting head being equipped with at least one respective cutting blade configured to cut off one of the sidewalls of said tire, said cutting heads being configured to cooperate so as to be able to cut off the two sidewalls of the tire at substantially the same time.

9. The machine according to claim 8, wherein the means for adjusting the relative position of the blade with respect to the connecting means comprise a slider with which said cutting heads are associated.

10. The machine according to claim 9, wherein said cutting heads are associated with the slider and are able to move in a direction substantially parallel to an axis of said tire when said tire is connected to said connecting means.

11. The machine according to claim 1, further comprising:
command and control means for said means for relative movement of said blade with respect to the tire, said command and control means being configured to regulate the speed of the relative movement of the blade with respect to the tire;
and detection means for detecting a signal that is representative of a vibration associated with cutting, said detection means being functionally connected to said command and control means in order to make available to the latter said signal that is representative of a vibration with respect to cutting and the command and control means being configured to regulate the speed of relative movement of the blade with respect to the tire depending on the detected value of said signal.

12. The machine according to claim 1, further comprising:
means for adjusting the depth of cutting, which act in operation on said blade or on said connecting means in order to allow the relative position of the blade to be adjusted with respect to the surface of a sidewall of said tire fixed to the connecting means so as to adjust the depth of cutting of the sidewall.

13. The machine according to claim 1, further comprising:
command and control means for the means for adjusting a cutting depth;
and detection means for detecting a signal that is representative of a vibration with respect to cutting, said detection means being connected to said command and control means in order to make available to the latter said signal that is representative of a vibration associated with cutting, the command and control means being configured to adjust the relative position of the blade with respect to the surface of a sidewall of said tire depending on the detected value of said signal.

14. The machine according to claim 1, further comprising pressing means configured to exert a squeezing action on at least one of the two sidewalls so as to facilitate the cutting action of said blade.

15. The machine according to claim 14, wherein said pressing means comprise a rotary element having two parts with different diameters, said parts being configured to come into contact with the surface of said sidewall.

16. A method for cutting off the sidewalls of a tire, comprising:
providing a frame;
providing connecting means configured to clamp the tire in a pre-established position with respect to the frame, in a zone for loading said tire, the connecting means for the tire comprising a carousel;
disposing a height-adjustable block that is intended to support the external part of the bead of the tire that comes into contact with said carousel;
providing at least one cutting head equipped with a cutting blade for cutting off a sidewall of said tire;
disposing the cutting blade in contact with the sidewall;
applying a relative movement to said blade and to said tire such that, during said relative movement, the cutting blade makes a cut along the circumference of the sidewall of the tire.

17. The method according to claim 16, wherein the step of applying a relative movement to said blade and to said tire provides for said tire to be set into movement with respect to the blade.

18. The method according to claim 16, wherein, in said step of applying a relative movement to said blade and to said tire, provision is made for a pressure to be applied to at least one of the two sidewalls in order to facilitate the cutting action of said blade.
